(19) United States
(12) Patent Application Publication
(10) Pub. No.: US 2024/0345562 A1
(43) Pub. Date: Oct. 17, 2024

(54) INFERENCE DEVICE

(71) Applicant: Fanuc Corporation, Minamitsuru-gun, Yamanashi (JP)

(72) Inventor: Takashi Miyoshi, Minamitsuru-gun, Yamanashi (JP)

(73) Assignee: Fanuc Corporation, Minamitsuru-gun, Yamanashi (JP)

(21) Appl. No.: 18/574,990

(22) PCT Filed: Jul. 29, 2021
(86) PCT No.: PCT/JP2021/028170

§ 371 Date: Dec. 28, 2023

(51) Int. Cl. G05B 19/4093; G05B 19/4061

(52) U.S. Cl. CPC G05B 19/40931; G05B 19/4061; G05B 2219/45236

(57) ABSTRACT

An inference device includes: a reception unit for receiving model information of a structure of a machine tool; a determination unit for determining, at the start of machining a polygon, an initial position of a center axis of the polygon, an initial phase of a rotary tool, and a position relationship between the center axis and a rotary axis of the rotary tool; a calculation unit for calculating a movement range of at least one of the rotary axis of the rotary tool and a rotary axis of workpiece based on the initial position of the center axis of the polygon, the initial phase of the rotary tool, and the position relationship between the center axis of the polygon and the rotary axis of the rotary tool; and an inference unit for inferring whether interference will occur in the machine tool, based on the model information and the movement range.

### CROSS REFERENCE TO RELATED APPLICATIONS

This is the U.S. National Phase application of PCT/JP2021/028170, filed Jul. 29, 2021, the disclosure of this application being incorporated herein by reference in its entirety for all purposes.

### FIELD OF THE INVENTION

The present disclosure relates to an estimation device that estimates whether interference occurs in a machine tool and to a computer-readable storage medium.

### BACKGROUND OF THE INVENTION

Conventionally, there is known a technique of machining a polygon on a workpiece surface by rotating a polygon machining tool (hereinafter, referred to as a rotary tool) and the workpiece in synchronization with each other (for example, Patent Literature 1). By utilizing this technique, it is possible to machine the polygon in a shorter time than the time required for performing a machining operation with a milling cutter.

Also, some attempts have been made to form a polygon on a workpiece at a position eccentric from a rotation axis of the workpiece by controlling a relative position between a center axis of the polygon and a rotation axis of a rotary tool.

### PATENT LITERATURE

Patent Literature 1: JP 2021-43732 A

### SUMMARY OF THE INVENTION

When a polygon is formed on a workpiece at a position eccentric from a rotation axis of the workpiece, however, a rotary tool needs to move extensively. In which case, the rotary tool and a structure of the machine tool may interfere with each other.

An object of the present disclosure is to provide an estimation device that, when a machine tool machines a polygon by controlling a relative position between a rotary tool and a center axis of the polygon, can estimate whether interference will occur in the machine tool prior to execution of the machining.

When a machine tool machines a polygon by controlling a relative position between a rotation axis of a rotary tool and a center axis of the polygon which is parallel to a rotation axis of a workpiece and passes through a predetermined position in the workpiece so that a positional relationship between the center axis of the polygon and the rotation axis of the rotary tool is kept constant, an estimation device estimates whether interference will occur in the machine tool. The estimation device includes: a reception unit that receives model information regarding a structure that constitutes the machine tool; a determination unit that, at a start of machining of the polygon, determines an initial position of the center axis of the polygon, an initial phase of the rotary tool, and a positional relationship between the center axis of the polygon and the rotation axis of the rotary tool; a calculation unit that calculates a moving range of at least one of the rotation axis of the rotary tool and the rotation axis of the workpiece, based on the initial position of the center axis of the polygon, the initial phase of the rotary tool, and the positional relationship between the center axis of the polygon and the rotation axis of the rotary tool which are determined by the determination unit; and an estimation unit that estimates whether interference will occur in the machine tool, based on the model information received by the reception unit and the moving range calculated by the calculation unit.

A computer-readable storage medium stores an instruction that causes a computer to, when a machine tool machines a polygon by controlling a relative position between a center axis of the polygon which is parallel to a rotation axis of a workpiece and passes through a predetermined position in the workpiece so that a positional relationship between the center axis of the polygon and the rotation axis of the rotary tool is kept constant, estimate whether interference will occur in the machine tool. The computer-readable storage medium stores the instruction that causes the computer to: receive model information regarding a structure that constitutes the machine tool; determine an initial position of the center axis of the polygon, an initial phase of the rotary tool, and a positional relationship between the center axis of the polygon and the rotation axis of the rotary tool at a start of machining of the polygon; calculate a moving range of at least one of the rotation axis of the rotary tool and the rotation axis of the workpiece, based on the initial position of the center axis of the polygon, the initial phase of the rotary tool, and the positional relationship between the center axis of the polygon and the rotation axis of the rotary tool which are determined; and estimate whether interference will occur in the machine tool, based on the received model information and the calculated moving range.

According to an aspect of the present disclosure, when a machine tool machines a polygon by controlling a relative position between a rotary tool and a center axis of the polygon, it is possible to estimate whether interference will occur in the machine tool prior to execution of the machining.

### BRIEF DESCRIPTION OF DRAWINGS

FIG. 1 is a block diagram illustrating an example of a hardware configuration of a machine tool.

FIG. 2 is a diagram illustrating an example of a polygon.

FIG. 3 is a diagram illustrating an example of the polygon.

FIG. 4 is a diagram illustrating an example of a path of a cutting edge of a rotary tool with respect to a workpiece.

FIG. 5 is a diagram illustrating an example of the path of the cutting edge of the rotary tool with respect to the workpiece.

FIG. 6 is a diagram illustrating an example of a function of a numerical controller.

FIG. 7 is a diagram illustrating an initial state.

FIG. 8 is a diagram illustrating a positional relationship between a rotation axis of the rotary tool and a center axis of the polygon.

FIG. 9 is a block diagram illustrating an example of a function of an estimation device.

FIG. 10 is a diagram illustrating an example of the initial state.

FIG. 11 is a diagram illustrating an example of a flow of a process executed by the estimation device.

FIG. 12 is a diagram illustrating an example case of changing an initial position of the center axis of the polygon.

### DETAILED DESCRIPTION OF EMBODIMENTS OF THE INVENTION

Hereinafter, embodiments of the present disclosure will be described below with reference to the accompanying drawings. It should be noted that not all the combinations of features described in the following embodiments are necessarily required for solving the above problem. Further, an unnecessarily detailed descriptions may be omitted. The following description of the embodiments and the drawings are provided for those skilled in the art to fully understand the present disclosure and not intended to limit the scope of the claims.

When a machine tool machines a polygon by controlling a relative position between the workpiece and a rotary tool, an estimation device estimates whether interference will occur in the machine tool prior to execution of the machining. The estimation device is implemented, for example, in a numerical controller that controls the machine tool. The estimation device may be implemented in a server connected to the numerical controller via a local area network (LAN). The estimation device may be implemented in a server connected to the numerical controller via the Internet. A description will be given below regarding an example case where the estimation device is implemented in the numerical controller.

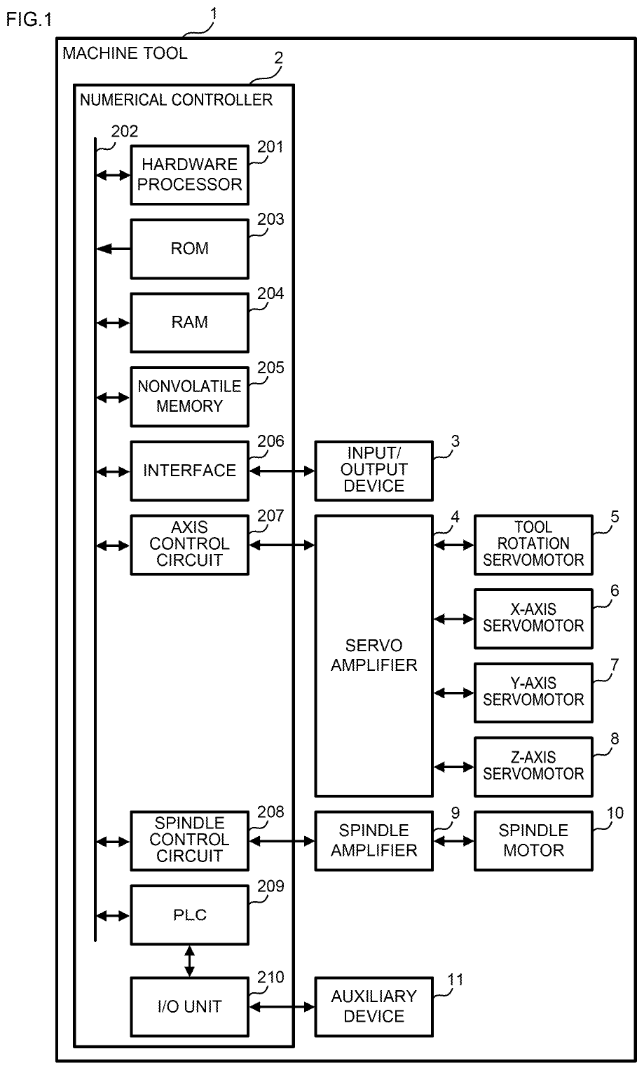

FIG. 1 is a block diagram illustrating an example of a hardware configuration of a machine tool that includes a numerical controller. A machine tool 1 includes a lathe, a machining center, and a multitasking machine.

The machine tool 1 includes a numerical controller 2, an input/output device 3, a servo amplifier 4, a tool rotation servomotor 5, an X-axis servomotor 6, a Y-axis servomotor 7, a Z-axis servomotor 8, a spindle amplifier 9, a spindle motor 10, and an auxiliary device 11.

The numerical controller 2 is a device that controls the entire machine tool 1. The numerical controller 2 includes a hardware processor 201, a bus 202, a read only memory (ROM) 203, a random access memory (RAM) 204, and a nonvolatile memory 205.

The hardware processor 201 is a processor that controls the entire numerical controller 2 in accordance with a system program. The hardware processor 201 reads the system program and the like stored in the ROM 203 via the bus 202 and then performs various types of processing based on the system program. The hardware processor 201 controls the tool rotation servomotor 5, the X-axis servomotor 6, the Y-axis servomotor 7, the Z-axis servomotor 8, and the spindle motor 10, based on a machining program. The hardware processor 201 is a central processing unit (CPU) or an electronic circuit, for example.

For each control cycle, for example, the hardware processor 201 analyzes the machining program and then outputs control commands to the tool rotation servomotor 5, the X-axis servomotor 6, the Y-axis servomotor 7, the Z-axis servomotor 8, and the spindle motor 10.

The bus 202 is a communication path that connects the pieces of hardware in the numerical controller 2 to each other. The pieces of the hardware in the numerical controller 2 exchange data via the bus 202.

The ROM 203 is a storage device that stores the system program and the like for controlling the entire numerical controller 2. The ROM 203 is a computer-readable storage medium.

The RAM 204 is a storage device that temporarily stores various types of data. The RAM 204 functions as a work area in which the hardware processor 201 processes various data.

The nonvolatile memory 205 is a storage device that retains data even in a state where the machine tool 1 is powered off and no power is supplied to the numerical controller 2. The nonvolatile memory 205 stores the machining program and various parameters, for example. The nonvolatile memory 205 is a computer-readable storage medium. The nonvolatile memory 205 includes a solid state drive (SSD), for example.

The numerical controller 2 further includes an interface 206, an axis control circuit 207, a spindle control circuit 208, a programmable logic controller (PLC) 209, and an input/output (I/O) unit 210.

The interface 206 connects the bus 202 and the input/output device 3. For example, the interface 206 transmits various data processed by the hardware processor 201 to the input/output device 3.

The input/output device 3 is a device that receives various data via the interface 206 and displays the data. In addition, the input/output device 3 accepts inputs of various data and transmits the data to the hardware processor 201 via the interface 206. The input/output device 3 is a touch panel, for example. If the input/output device 3 is a touch panel, this touch panel may be a capacitive touch panel, for example. However, the touch panel is not limited to a capacitive touch panel and may also be another type of touch panel. The input/output device 3 is installed, for example, on an operation panel (not illustrated) in which the numerical controller 2 is housed.

The axis control circuit 207 is a circuit that controls the tool rotation servomotor 5, the X-axis servomotor 6, the Y-axis servomotor 7, and the Z-axis servomotor 8. In response to receiving a control command from the hardware processor 201, the axis control circuit 207 outputs, to the servo amplifier 4, various commands for driving the tool rotation servomotor 5, the X-axis servomotor 6, the Y-axis servomotor 7, and the Z-axis servomotor 8. For example, the axis control circuit 207 transmits, to the servo amplifier 4, torque commands for controlling torques of the tool rotation servomotor 5, the X-axis servomotor 6, the Y-axis servomotor 7, and the Z-axis servomotor 8.

In response to receiving the commands from the axis control circuit 207, the servo amplifier 4 supplies currents to the tool rotation servomotor 5, the X-axis servomotor 6, the Y-axis servomotor 7, and the Z-axis servomotor 8.

The tool rotation servomotor 5 is driven by the current supplied from the servo amplifier 4. The tool rotation servomotor 5 is coupled to a shaft of a rotary tool installed, for example, on a tool post. The tool rotation servomotor 5 is driven to rotate the rotary tool. The rotary tool may be a polygon cutter, for example.

The X-axis servomotor 6 is driven by the current supplied from the servo amplifier 4. The X-axis servomotor 6 is coupled to, for example, a ball screw that drives a tool post. The X-axis servomotor 6 is driven to move a structure, such as a tool post, in the machine tool 1 in the X-axis directions. In addition, the X-axis servomotor 6 may include a speed detector (not illustrated) that detects a feed rate along the X-axis.

The Y-axis servomotor 7 is driven by the current supplied from the servo amplifier 4. The Y-axis servomotor 7 is coupled to, for example, the ball screw that drives the tool post. The Y-axis servomotor 7 is driven to move the structure, such as the tool post, in the machine tool 1 in the Y-axis directions. In addition, the Y-axis servomotor 7 may include a speed detector (not illustrated) that detects a feed rate along the Y-axis.

The Z-axis servomotor 8 is driven by the current supplied from the servo amplifier 4. The Z-axis servomotor 8 is coupled to, for example, the ball screw that drives the tool post. The Z-axis servomotor 8 is driven to move the structure, such as the tool post, in the machine tool 1 in the Z-axis directions. The Z-axis servomotor 8 may include a speed detector (not illustrated) that detects a feed rate along the Z-axis.

The spindle control circuit 208 is a circuit that controls the spindle motor 10. In response to receiving the control command from the hardware processor 201, the spindle control circuit 208 outputs a command for driving the spindle motor 10 to the spindle amplifier 9. For example, the spindle control circuit 208 transmits a torque command for controlling the torque of the spindle motor 10 to the spindle amplifier 9.

In response to receiving the command from the spindle control circuit 208, the spindle amplifier 9 supplies the current to the spindle motor 10.

The spindle motor 10 is driven by the current supplied from the spindle amplifier 9. The spindle motor 10 is coupled to a spindle and rotates this spindle. The spindle motor 10 includes an angle detector (not illustrated) that detects a rotation angle of the spindle.

The PLC 209 is a device that executes a ladder program to control the auxiliary device 11. The PLC 209 transmits a command to the auxiliary device 11 via the I/O unit 210.

The I/O unit 210 is an interface that connects the PLC 209 and the auxiliary device 11. The I/O unit 210 transmits a command received from the PLC 209 to the auxiliary device 11.

The auxiliary device 11 is a device that is installed in the machine tool 1 and performs an auxiliary operation in the machine tool 1. The auxiliary device 11 operates based on a command received from the I/O unit 210. The auxiliary device 11 may be a device installed around the machine tool 1. The auxiliary device 11 is a tool changer, a cutting fluid injection device, or an opening/closing door drive device, for example.

Next, a function of the numerical controller 2 will be described. The numerical controller 2 executes polygon machining by controlling the tool rotation servomotor 5, the X-axis servomotor 6, the Y-axis servomotor 7, the Z-axis servomotor 8, and the spindle motor 10. The polygon machining is a machining to form a cross-sectional shape of a workpiece into a polygonal shape. Here, the cross section is a cross section orthogonal to a rotation axis of the workpiece. More specifically, the numerical controller 2 performs a machining of forming a polygon on the workpiece at a position eccentric from the rotation axis of the workpiece.

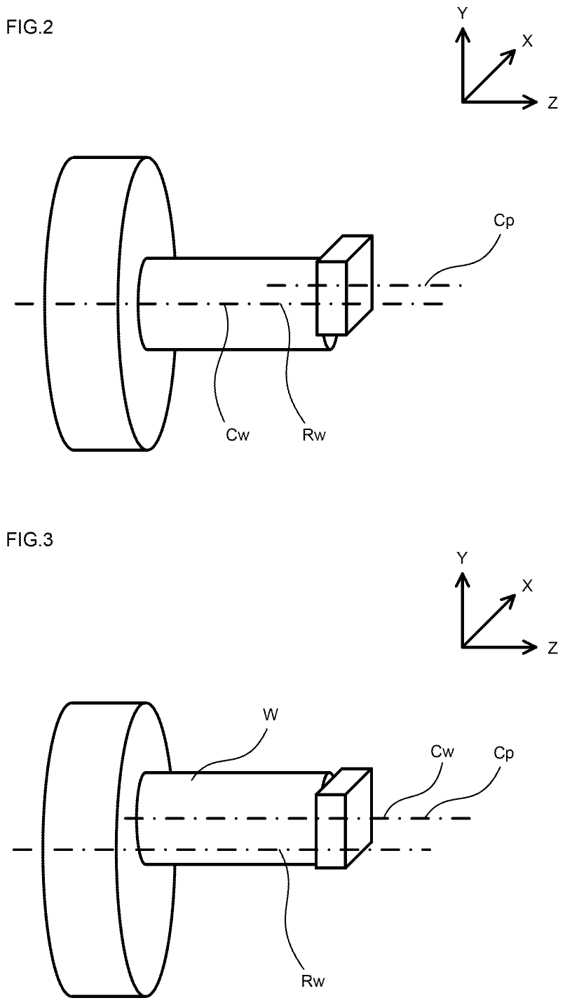

FIG. 2 is a diagram illustrating an example of a polygon formed on a workpiece at a position eccentric from the rotation axis of the workpiece. A rotation axis Rw of the workpiece is a rotation center of the workpiece. That is, a center axis Cp of the polygon is located at a position shifted from the rotation axis Rw of the workpiece, in other words, at a position different from the rotation axis Rw of the workpiece.

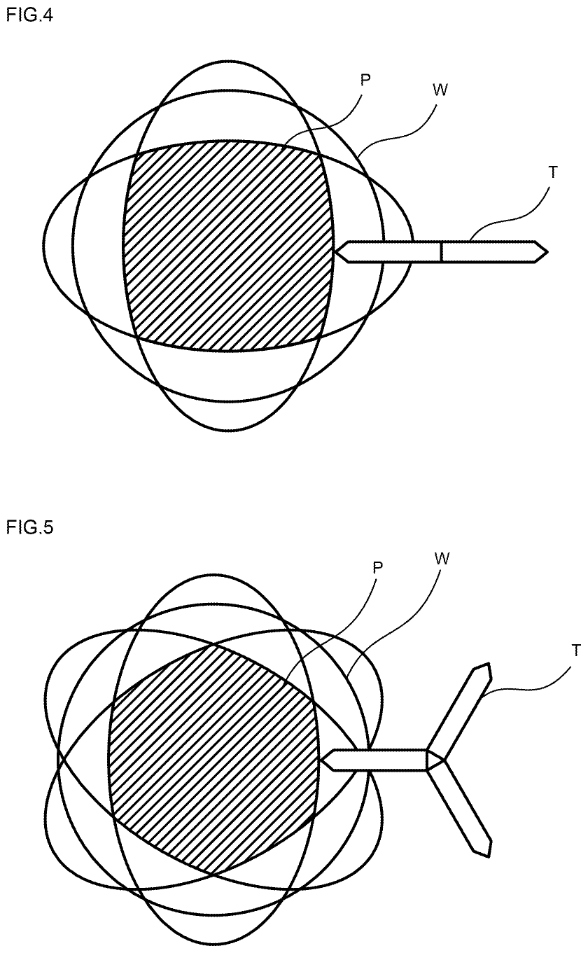

In the example illustrated in FIG. 2, a center axis Cw of the workpiece and the rotation axis Rw of the workpiece coincide with each other; however, they do not necessarily coincide with each other. When a workpiece W is gripped by an eccentric chuck at a position eccentric from the rotation axis Rw of the workpiece, for example, as illustrated in FIG. 3, the center axis Cw of the workpiece does not coincide the rotation axis Rw of the workpiece.

The numerical controller 2 rotates both the workpiece W and the rotary tool at a constant rotation speed ratio while keeping a relative position between a center axis Cp of the polygon and the rotation axis of the rotary tool constant. In this way, the polygon is machined on the surface of the workpiece W. When the rotation speed ratio of the workpiece W and the rotary tool is 1:2, for example, a relative path of a cutting edge of the rotary tool with respect to the workpiece W is expressed by the following Mathematical Formula 1.

$$\begin{matrix}{x}_{n} = l \times cos ( ω t ) + r \times cos ( ω t + 2 π \times n / N ) \\ {y}_{n} = - l \times sin ( ω t ) + r \times sin ( ω t + 2 π \times n / N )\end{matrix} \qquad [ Mathematical formula 1 ]$$

Here, Xn and Yn are paths of the cutting edge in an orthogonal coordinate system with the center axis Cp of the polygon as an origin, @ is a rotation speed of the workpiece W, 1 is a distance between the center axis Cp of the polygon and the rotation axis of the rotary tool, r is a radius of the rotary tool, N is the number of blades of the rotary tool T, and n (=1 to N) is a number of the cutting edge. The number of the cutting edge is a number given to each cutting edge in order from 1 in order to identify each cutting edge of a rotary tool T.

FIG. 4 is a diagram illustrating a path of a cutting edge of a rotary tool T with respect to the workpiece W when the rotation speed ratio between the workpiece W and the rotary tool T is 1:2 and polygon machining is performed using a rotary tool T having two blades. In this example, the rotary tool T makes two rotations while the workpiece W makes one rotation. The path of each blade of the rotary tool T draws an ellipse, and the major axes of the respective ellipses are orthogonal to each other. Therefore, as illustrated in FIG. 4, a polygon P having four surfaces is formed on the workpiece W.

FIG. 5 is a diagram illustrating a path of the cutting edge of the rotary tool T with respect to the workpiece W when the rotation speed ratio between the workpiece W and the rotary tool T is 1:2 and polygon machining is performed using the rotary tool T having three blades. In this example, the rotary tool T makes two rotations while the workpiece W makes one rotation. Further, the path of each blade of the rotary tool T draws an ellipse, and the major axes of the respective ellipses intersect each other at the angle of 120°. Therefore, as illustrated in FIG. 5, the polygon P having six surfaces is formed on the workpiece W. Here, as an example, a description has been given as to machining when the rotation speed ratio between the workpiece W and the rotary tool T is 1:2, but a polygon is formed as long as the product of the ratio of the rotation speed of the rotary tool T to the rotation speed of the workpiece W and the number of blades is an integer of three or more.

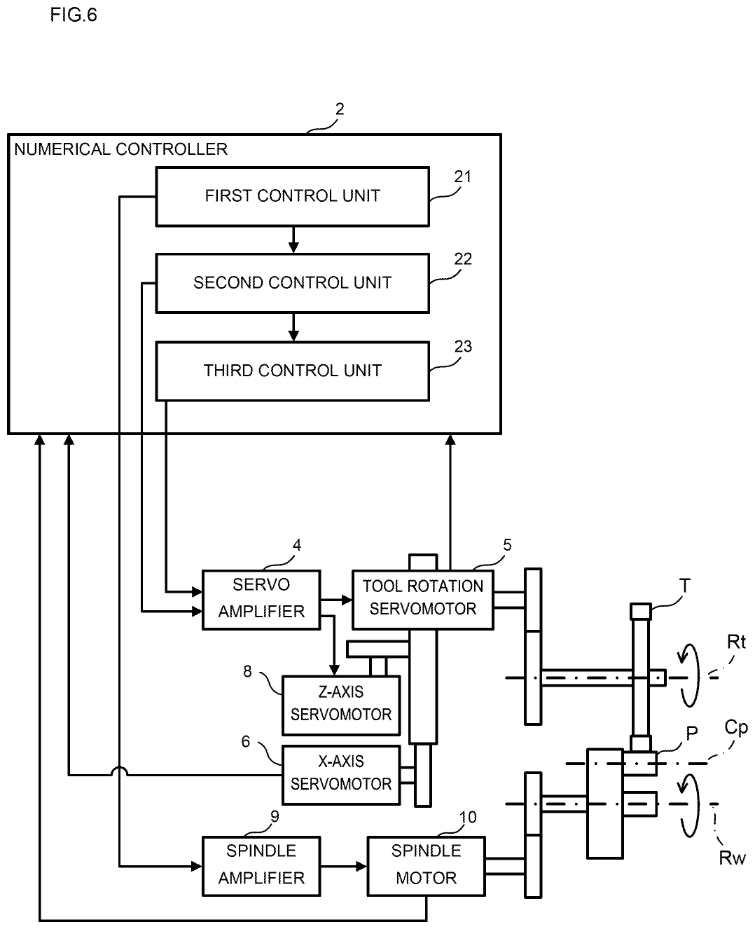

FIG. 6 is a block diagram illustrating an example of a function of the numerical controller 2. The numerical controller 2 includes a first control unit 21, a second control unit 22, and a third control unit 23. The first control unit 21, the second control unit 22, and the third control unit 23 are implemented, for example, by allowing the hardware processor 201 to execute an arithmetic process using the system program stored in the ROM 203, the machining program and various data stored in the nonvolatile memory 205.

The first control unit 21 controls the spindle motor 10 to move the center axis Cp of the polygon to the initial position before polygon machining is started. Before the machining of the polygon P is started, the second control unit 22 controls the tool rotation servomotor 5 to move the blade of the rotary tool T to the initial position. In other words, the second control unit 22 adjusts the phase of the rotary tool T to the initial phase. The third control unit 23 controls at least one of the X-axis servomotor 6 and the Y-axis servomotor 7 to move the rotation axis Rt of the rotary tool to the initial position so that a positional relationship between the center axis Cp of the polygon and the rotation axis Rt of the rotary tool becomes a predetermined positional relationship. Each of the rotation axis Rt of the rotary tool and the rotation axis Rw of the workpiece may be driven by the spindle motor 10 or may be driven by a servomotor.

Hereinafter, a state in which the center axis Cp of the polygon is disposed at the initial position, a state in which the phase of the rotary tool T is the initial phase, and a state in which the positional relationship between the center axis Cp of the polygon and the rotation axis Rt of the rotary tool is a predetermined positional relationship at the start of machining of the polygon P are referred to as initial states.

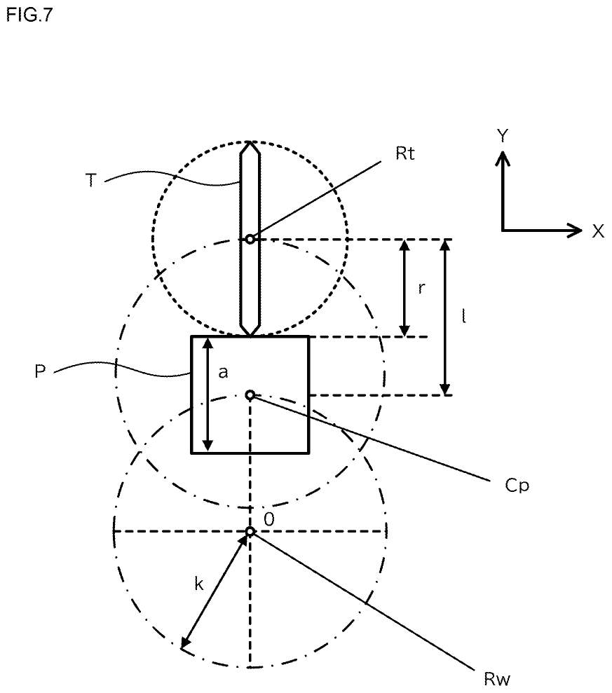

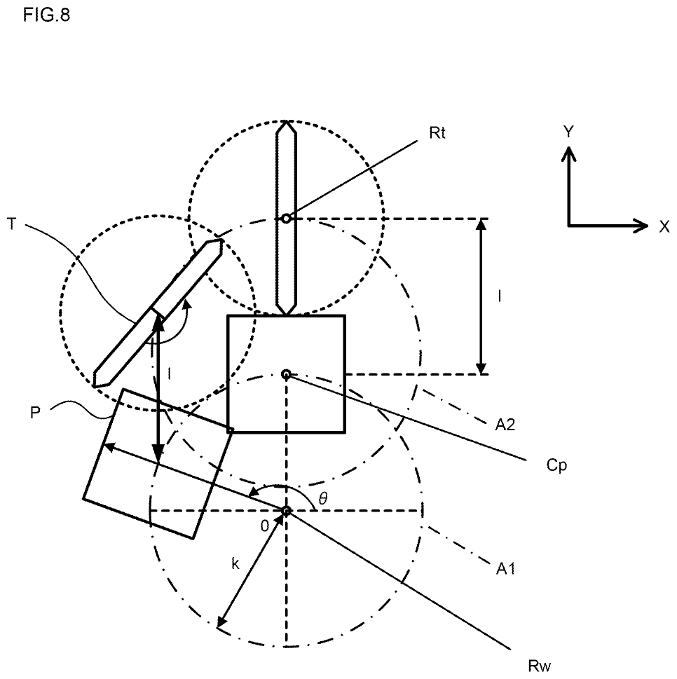

FIG. 7 is a diagram illustrating an initial state. Here, the initial state will be described using a two-dimensional orthogonal coordinate system in which the rotation axis Rw of the workpiece is the origin, the right direction is the positive direction of the X axis, and the upper direction is the positive direction of the Y axis for convenience.

The initial position of the center axis Cp of the polygon is, for example, a position at which the X coordinate is 0 and the Y coordinate is k. Here, k is a distance between the rotation axis Rw of the workpiece and the center axis Cp of the polygon. The initial phase of the rotary tool T is, for example, a phase in which one blade faces the direction of the center axis Cp of the polygon. Further, a position at which the center axis Cp of the polygon and the rotation axis Rt of the rotary tool have a predetermined positional relationship is, for example, a position at which the X coordinate of the rotation axis Rt of the rotary tool is 0 and the Y coordinate is k+l. It is noted that l is a value obtained by multiplying a value obtained by adding a diameter 2r of the rotary tool T and a distance a between a pair of surfaces of the polygon P by ½.

When the center axis Cp of the polygon, the phase of the rotary tool T, and the positional relationship between the center axis Cp of the polygon and the rotation axis Rt of the rotary tool are in the initial state, the first control unit 21, for example, rotates the workpiece W around the rotation axis Rw of the workpiece by controlling the spindle motor 10. The rotation axis Rw of the workpiece is, for example, a center axis of a spindle. The rotation axis Rw of the workpiece may be the center of a shaft connected to a rotary table.

For example, when the first control unit 21 rotates the spindle in a state in which the workpiece W is held by a chuck connected to the spindle, the first control unit 21 rotates the workpiece W around the rotation axis Rw of the workpiece.

The second control unit 22 rotates the rotary tool T around the rotation axis Rt of the rotary tool at a rotation speed of a constant ratio with respect to the rotation speed of the workpiece W.

For example, the second control unit 22 rotates the rotary tool T at a speed twice as fast as the rotation speed of the workpiece W. That is, the second control unit 22 rotates the rotary tool T so that the rotation speed ratio between the workpiece W and the rotary tool T is set to 1:2. For example, this case uses the rotary tool T having two blades respectively disposed at different positions and separated from each other by 180° around the rotation axis Rt of the rotary tool T. Alternatively, it may be possible to use the rotary tool T having three blades respectively disposed at different positions and separated from each other by 120° around the rotation axis Rt of the rotary tool. The rotation speed ratio of the workpiece W and the rotary tool T and the number of blades of the rotary tool T are not limited to these examples. The rotation speed ratio of the workpiece W and the rotary tool T and the number of blades of the rotary tool T are determined depending on the shape of the polygon P to be formed.

The third controller 23 controls the relative position between the rotation axis Rt of the rotary tool and the center axis Cp of the polygon so that the positional relationship between the center axis Cp of the polygon which is parallel to the rotation axis Rw of the workpiece and passes through a predetermined position in the workpiece W and the rotation axis Rt of the rotary tool is kept constant.

In the present embodiment, the position of the rotation axis Rw of the workpiece is fixed. Therefore, the third control unit 23 controls the relative position between the rotation axis Rt of the rotary tool and the center axis Cp of the polygon by controlling the position of the rotation axis Rt of the rotary tool. However, the position of the rotation axis Rt of the rotary tool may be fixed, and the position of the rotation axis Rw of the workpiece may be movable. In this case, the third control unit 23 controls the positional relationship between the rotation axis Rt of the rotary tool and the center axis Cp of the polygon by controlling the position of the rotation axis Rw of the workpiece.

FIG. 8 is a diagram illustrating a positional relationship between the rotation axis Rt of the rotary tool and the center axis Cp of the polygon. In the example illustrated in FIG. 8, the X coordinate of the center axis Cp of the polygon and the X coordinate of the rotation axis Rt of the rotary tool are always the same. The Y coordinate of the rotation axis Rt of the rotary tool is always a value obtained by adding 1 to the Y coordinate of the center axis Cp of the polygon. That is, assuming that a path along which the center axis Cp of the polygon moves is defined as (Xt, Yt), a path along which the rotation axis Rt of the rotary tool moves can be represented as (Xt, Yt+1). The center coordinates of the path along which the rotation axis Rt of the rotary tool moves are (0, 1).

The third controller 23 controls the relative position between the rotation axis Rt of the rotary tool and the center axis Cp of the polygon so that the positional relationship between the center axis Cp of the polygon and the rotation axis Rt of the rotary tool is kept constant, thereby machining the polygon P. The polygon P is machined around the center axis Cp of the polygon, which passes through a predetermined position separated from the rotation axis Rw of the workpiece by k. The center axis Cp of the polygon moves on a circumference of a circle A1 with a radius k having the rotation axis Rw of the workpiece as a center thereof. The third controller 23 moves the rotation axis Rt of the rotary tool on a circumference of a circle A2 with the radius k so that the relative position between the rotation axis Rt of the rotary tool and the center axis Cp of the polygon is kept constant.

The third controller 23 may identify the position of the center axis Cp of the polygon with respect to the position of the rotation axis Rw of the workpiece based on a rotation angle θ of the rotation axis Rw of the workpiece and a distance between the rotation axis Rw of the workpiece and the center axis Cp of the polygon. The rotation angle θ of the rotation axis Rw of the workpiece is an angle between a portion indicating a positive value on the X-axis and a line segment connecting the rotation axis Rw of the workpiece and the origin in an orthogonal coordinate system having the rotation axis Rw of the workpiece as the origin.

The third control unit 23 calculates the rotation angle θ of the rotation axis Rw of the workpiece based on, for example, information detected by an angle detector installed in the spindle motor 10. In addition, for example, the third control unit 23 reads, from the machining program, a value indicating the distance between the rotation axis Rw of the workpiece and the center axis Cp of the polygon. Accordingly, the third control unit 23 identifies the position of the center axis Cp of the polygon with respect to the position of the rotation axis Rw of the workpiece. The third control unit 23 may control the relative position between the center axis Cp of the polygon and the rotation axis Rt of the rotary tool using a feedback value of the rotation angle θ of the rotation axis Rw of the workpiece.

When machining of the polygon P is started, the third control unit 23 may cause the rotation axis Rt of the rotary tool to be close to the center axis Cp of the polygon by cutting feed until the positional relationship between the center axis Cp of the polygon and the rotation axis Rt of the rotary tool becomes a positional relationship in the initial state.

Alternatively, when moving the position of the rotation axis Rt of the rotary tool to the initial position, the third control unit 23 may position the rotary tool T, for example, at a position separated from one end of the workpiece W by a predetermined distance in the Z-axis direction so that the rotary tool T does not come into contact with a part of the workpiece W. In this case, the rotary tool T moves in the Z-axis direction to machine the polygon P.

Next, a function of an estimation device will be described. When the machine tool 1 machines a polygon by controlling the relative position between the rotation axis Rw of the workpiece and the rotation axis Rt of the rotary tool so that the positional relationship between the rotation axis Rt of the rotary tool and the center axis Cp of the polygon which is parallel to the rotation axis Rw of the workpiece and passes through a predetermined position of the workpiece W is kept constant, the estimation device estimates whether interference will occur in the machine tool 1.

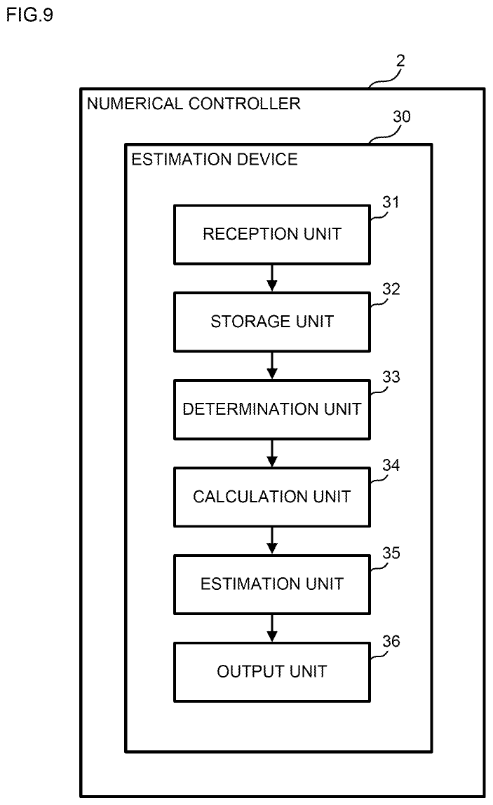

FIG. 9 is a block diagram illustrating an example of a function of the estimation device. An estimation device 30 includes, for example, a reception unit 31, a storage unit 32, a determination unit 33, a calculation unit 34, an estimation unit 35, and an output unit 36.

The reception unit 31, the determination unit 33, the calculation unit 34, the estimation unit 35, and the output unit 36 is implemented, for example, by allowing the hardware processor 201 to execute an arithmetic process using the system program stored in the ROM 203, the machining program and various data stored in the nonvolatile memory 205. The storage unit 32 is implemented, for example, by storing, in the RAM 204 or the nonvolatile memory 205, data and various parameters received from the input/output device 3, an external server, or the like.

The reception unit 31 receives model information regarding a structure that constitutes the machine tool 1. Examples of the structure that constitutes the machine tool 1 include a headstock, a chuck, a tool post, a rotary tool T, a telescopic cover, and a splash guard. The model information may be information regarding a three-dimensional model of the structure, for example. The information regarding the three-dimensional model may be three-dimensional computer aided design (CAD) data, for example. The reception unit 31 may receive the model information regarding the structure that constitutes the machine tool 1, for example, from an external server.

The storage unit 32 stores the model information received by the reception unit 31.

The determination unit 33 determines, at the start of the machining of the polygon P, the initial position of the center axis Cp of the polygon, the initial phase of the rotary tool T, and the positional relationship between the center axis Cp of the polygon and the rotation axis Rt of the rotary tool. In other words, the determination unit 33 determines the initial state of the center axis Cp of the polygon, the phase of the rotary tool T, and the positional relationship between the center axis Cp of the polygon and the rotation axis Rt of the rotary tool.

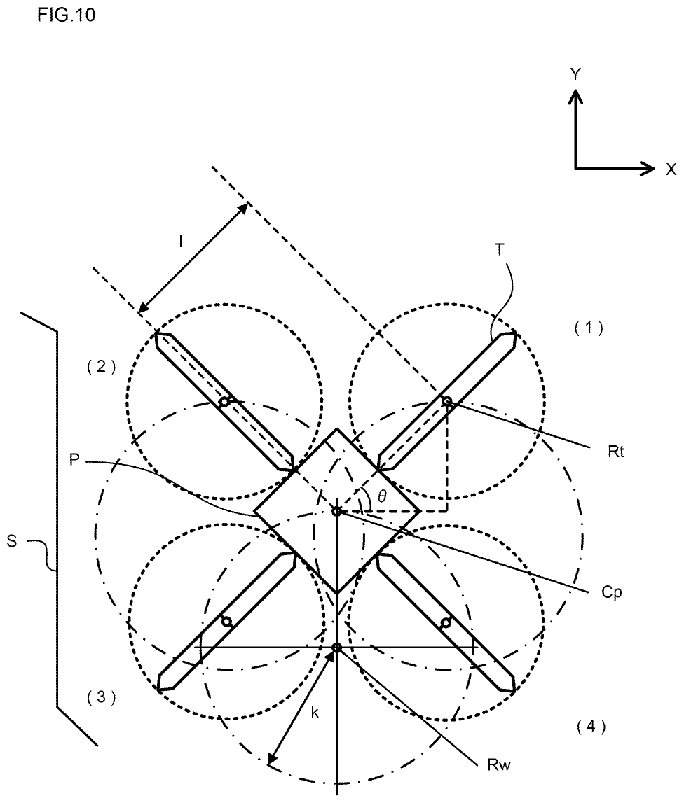

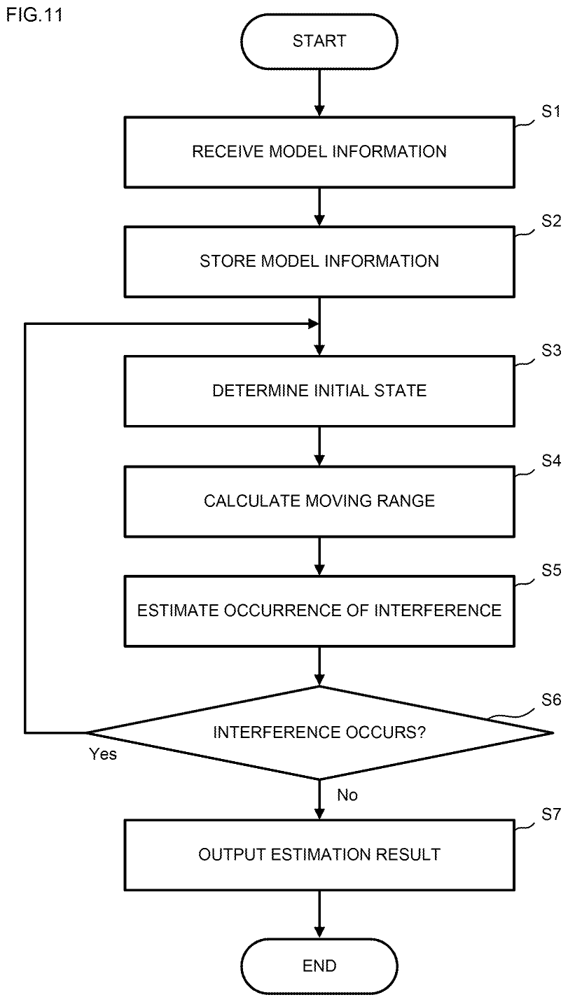

FIG. 10 is a diagram illustrating an example of the initial state. The determination unit 33 determines that the initial position of the center axis Cp of the polygon is, for example, a position at which the X coordinate is 0 and the Y coordinate is k. In this case, k indicates a distance between the rotation axis Rw of the workpiece and the center axis Cp of the polygon.

The determination unit 33 determines that the initial phase of the rotary tool T, for example, is a position at which one blade faces in a direction toward the center axis Cp of the polygon.

For example, the determination unit 33 determines the positional relationship between the center axis Cp of the polygon and the rotation axis Rt of the rotary tool so that the rotation axis Rt of the rotary tool is disposed 45° above the center axis Cp of the polygon and the distance between the rotation axis Rt of the rotary tool and the center axis Cp of the polygon becomes l (see (1) in FIG. 10.). In this case, l is a value obtained by multiplying, by ½, a value obtained by adding the diameter of the rotary tool T to the distance between the pair of surfaces of the polygon P. In short, when the coordinates of the center axis Cp of the polygon are (0, k), the positional coordinates of the rotation axis Rt of the rotary tool are (l cos 45°, k+l sin) 45°.

The calculation unit 34 calculates a moving range of the rotation axis Rt of the rotary tool, based on the initial position of the center axis Cp of the polygon, the initial phase of the rotary tool T, and the positional relationship between the center axis Cp of the polygon and the rotation axis Rt of the rotary tool, all of which are determined by the determination unit 33. When the position of the rotation axis Rw of the workpiece is movable, the calculation unit 34 calculates a moving range of the rotation axis Rw of the workpiece.

The calculation unit 34 also calculates a moving range of the cutting edge of the rotary tool T when the rotation axis Rt of the rotary tool moves within the moving range.

The estimation unit 35 estimates whether interference will occur in the machine tool 1, based on the model information received by the reception unit 31 and the moving range of the rotation axis Rt of the rotary tool calculated by the calculation unit 34. For example, the estimation unit 35 superimposes the moving range of the rotation axis Rt of the rotary tool or the moving range of the cutting edge of the rotary tool T onto the three-dimensional model of the structure received by the reception unit 31. In this way, the estimation unit 35 determines whether the structure at least overlaps the rotary tool T.

When the structure S at least overlaps the rotary tool T, the estimation unit 35 estimates that interference will occur in the machine tool 1. When the structure S does not overlap the rotary tool T, the estimation unit 35 estimates that no interference will occur in the machine tool 1.

The output unit 36 outputs an estimation result estimated by the estimation unit 35. For example, the output unit 36 may output the estimation result estimated by the estimation unit 35 to the input/output device 3.

When the estimation unit 35 estimates that the interference will occur, the determination unit 33 changes at least one of the initial position of the center axis Cp of the polygon, the initial phase of the rotary tool T, and the positional relationship between the center axis Cp of the polygon and the rotation axis Rt of the rotary tool at the start of the machining of the polygon P. In short, the determination unit 33 repeats changing the initial state until the estimation unit 35 estimates that no interference will occur.

The determination unit 33 determines the positional relationship between the center axis Cp of the polygon and the rotation axis Rt of the rotary tool, for example, so that the rotation axis Rt of the rotary tool is positioned 135° above the center axis Cp of the polygon and the distance between the rotation axis Rt of the rotary tool and the center axis Cp of the polygon becomes l (see (2) in FIG. 10). In this case, the coordinates of the position of the rotation axis Rt of the rotary tool are (l cos 135°, k+l sin) 135°.

The determination unit 33 determines the phase of the rotary tool T in accordance with the position of the rotation axis Rt of the rotary tool. For example, the determination unit 33 determines that the phase is a position at which one blade faces in the direction toward the center axis Cp of the polygon. In short, the determination unit 33 determines that the phase of the rotary tool T is that indicated by the rotary tool T in (2) of FIG. 10. In this case, the phase of the rotary tool T in (2) of FIG. 10 is equal to a value obtained by adding 90° to the phase of the rotary tool T in (1) of FIG. 10.

The estimation unit 35 re-estimates whether the interference will occur in the machine tool 1, based on the initial position of the center axis Cp of the polygon, the initial phase of the rotary tool T, and the positional relationship between the center axis Cp of the polygon and the rotation axis Rt of the rotary tool, all of which are changed by the determination unit 33.

In the example illustrated in FIG. 10, the estimation unit 35 estimates that interference will occur at any of the positions (1) to (3). The estimation unit 35, however, estimates that no interference will occur at the position illustrated in (4).

It is noted that the first control unit 21, the second control unit 22, and the third control unit 23 may determine the initial position of the center axis Cp of the polygon, the initial phase of the rotary tool T, and the positional relationship between the center axis and the rotation axis Rt of the rotary tool, based on the result estimated by the estimation unit 35 and then may machine the polygon P.

Next, a flow of a process executed by the estimation device 30 will be described.

FIG. 11 is a diagram illustrating an example of the process flow executed by the estimation device 30.

The reception unit 31 receives the model information regarding a structure S that constitutes the machine tool 1 (Step S1).

The storage unit 32 then stores the model information received by the reception unit 31 (Step S2).

The determination unit 33 then determines the initial state of the center axis Cp of the polygon, the phase of the rotary tool T, and the positional relationship between the center axis Cp of the polygon and the rotation axis Rt of the rotary tool (Step S3).

The calculation unit 34 then calculates the moving range of at least one of the rotation axis Rt of the rotary tool and the rotation axis Rw of the workpiece (Step S4).

The estimation unit 35 then estimates whether interference will occur in the machine tool 1, based on the moving range calculated by the calculation unit 34 (Step S5).

When the estimation unit 35 estimates that the interference will occur (Yes in Step S6), the determination unit 33 re-determines the initial state. In short, the determination unit 33 changes the initial state.

When the estimation unit 35 estimates that no interference will occur (No in step S6), the output unit 36 outputs the estimation result (step S7), so that the process ends.

As described above, when a machine tool 1 machines a polygon by controlling a relative position between a rotation axis Rt of a rotary tool and a center axis Cp of the polygon which is parallel to a rotation axis Rw of a workpiece and passes through a predetermined position in the workpiece W so that a positional relationship between the center axis Cp of the polygon and the rotation axis Rt of the rotary tool is kept constant, an estimation device 30 estimates whether interference will occur in the machine tool. The estimation device 30 includes: a reception unit 31 that receives model information regarding a structure S that constitutes the machine tool 1; a determination unit 33 that, at a start of machining of the polygon P, determines an initial position of the center axis Cp of the polygon, an initial phase of the rotary tool T, and a positional relationship between the center axis Cp of the polygon and the rotation axis Rt of the rotary tool; a calculation unit 34 that calculates a moving range of at least one of the rotation axis Rt of the rotary tool and the rotation axis Rw of the workpiece, based on the initial position of the center axis Cp of the polygon, the initial phase of the rotary tool T, and the positional relationship between the center axis Cp of the polygon and the rotation axis Rt of the rotary tool which are determined by the determination unit 33; and an estimation unit 35 that estimates whether interference will occur in the machine tool 1, based on the model information received by the reception unit 31 and the moving range calculated by the calculation unit 34. In this case, when the machine tool 1 machines the polygon by controlling the relative position between the workpiece W and the rotary tool T, the estimation device 30 can estimate whether interference will occur in the machine tool 1 prior to execution of the machining.

In the foregoing embodiment, when the estimation unit 35 estimates that interference will occur, the determination unit 33 changes the positional relationship between the center axis Cp of the polygon and the rotation axis Rt of the rotary tool at the start of the machining. The determination unit 33, however, may change the initial position of the center axis Cp of the polygon at the start of the machining of the polygon.

For example, if the machine tool 1 starts machining the polygon in the initial state illustrated in any of (1) to (4) of FIG. 10, when the estimation unit 35 estimates that interference will occur in the machine tool 1, the determination unit 33 changes the initial position of the center axis Cp of the polygon at the start of the machining of the polygon.

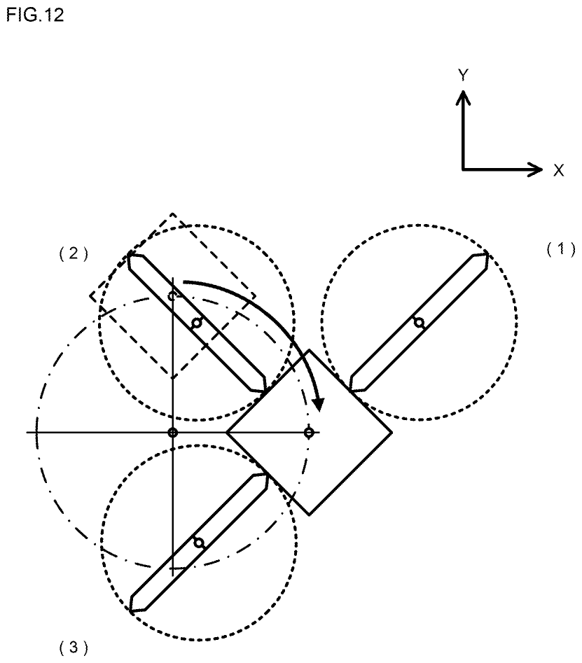

FIG. 12 is a diagram illustrating an example case of changing the initial position of the center axis Cp of the polygon. The determination unit 33 determines that the initial position of the center axis Cp of the polygon is, for example, a position at which the X coordinate is k and the Y coordinate is 0, in a two-dimensional orthogonal coordinate system having the rotation axis Rw of the workpiece as the origin. In this case, k indicates a distance between the rotation axis Rw of the workpiece and the center axis Cp of the polygon.

The determination unit 33 determines that the initial phase of the rotary tool T, for example, is a position at which one blade faces in a direction toward the center axis Cp of the polygon.

The determination unit 33 determines the positional relationship between the center axis Cp of the polygon and the rotation axis Rt of the rotary tool, for example, so that the rotation axis Rt of the rotary tool is positioned 45° above the center axis Cp of the polygon and the distance between the rotation axis Rt of the rotary tool and the center axis Cp of the polygon becomes l (see (1) in FIG. 12). Here, l is a value obtained by multiplying, by ½, a value obtained by adding the diameter of the rotary tool T to the distance between the pair of surfaces of the polygon P. In this case, the coordinates of the rotation axis Rt of the rotary tool are (k+l cos 45°, l sin) 45°.

The calculation unit 34 calculates a moving range of the rotation axis Rt of the rotary tool, based on the initial position of the center axis Cp of the polygon, the initial phase of the rotary tool T, and the positional relationship between the center axis Cp of the polygon and the rotation axis Rt of the rotary tool, all of which are determined by the determination unit 33. When the position of the rotation axis Rw of the workpiece is movable, the calculation unit 34 calculates a moving range of the rotation axis Rw of the workpiece.

The calculation unit 34 also calculates a moving range of the cutting edge of the rotary tool T when the rotation axis Rt of the rotary tool moves within the moving range.

The estimation unit 35 estimates whether interference will occur in the machine tool 1, based on the model information received by the reception unit 31 and the moving range of the rotation axis Rt of the rotary tool which is calculated by the calculation unit 34.

When the estimation unit 35 estimates that the interference will still occur, the determination unit 33 changes the position of the rotation axis Rt of the rotary tool with respect to the center axis Cp of the polygon.

The determination unit 33 determines the positional relationship between the center axis Cp of the polygon and the rotation axis Rt of the rotary tool, for example, so that the rotation axis Rt of the rotary tool is positioned 135° above the center axis Cp of the polygon and the distance between the rotation axis Rt of the rotary tool and the center axis Cp of the polygon becomes l (see the position indicated in (2) in FIG. 12). In this case, the coordinates of the rotation axis Rt of the rotary tool are (k+l cos 135°, l sin) 135°.

The determination unit 33 determines the phase of the rotary tool T in accordance with the position of the rotation axis Rt of the rotary tool. For example, the determination unit 33 determines that the phase is a position at which one blade faces in the direction toward the center axis Cp of the polygon. In short, for example, the determination unit 33 determines that the phase of the rotary tool T is that indicated by the rotary tool T at the position (2) in FIG. 12. In this case, the phase of the rotary tool T illustrated at the position (2) in FIG. 12 is equal to a value obtained by adding 90° to the phase of the rotary tool T illustrated at the position (1) in FIG. 12.

The estimation unit 35 re-estimates whether the interference will occur in the machine tool 1, based on the initial position of the center axis Cp of the polygon, the initial phase of the rotary tool T, and the positional relationship between the center axis Cp of the polygon and the rotation axis Rt of the rotary tool, all of which are changed by the determination unit 33.

In the example illustrated in FIG. 12, the estimation unit 35 estimates that interference will occur at the positions (1) and (2). The estimation unit 35, however, estimates that no interference will occur at the position illustrated in (3).

In the foregoing embodiment, the determination unit 33 changes the initial position of the center axis Cp of the polygon at the start of the machining of the polygon. The determination unit 33, however, may change the initial phase of the rotary tool T. More specifically, when the estimation unit 35 estimates that interference will occur, the determination unit 33 may change at least one of the initial position of the center axis Cp of the polygon, the initial phase of the rotary tool T, and the positional relationship between the center axis Cp of the polygon and the rotation axis Rt of the rotary tool at the start of the machining. In this case, the estimation device 30 can efficiently find a position at which no interference will occur in the machine tool 1.

It should be noted that the present disclosure is not limited to the foregoing embodiment and may be modified as appropriate without departing from the spirit. In the present disclosure, any of the components in the embodiment may be modified. In addition, any of the components in the embodiment may be omitted.

### REFERENCE SIGNS LIST

1 Machine tool
2 Numerical controller
201 Hardware processor
202 Bus
203 ROM
204 RAM
205 Nonvolatile memory
206 Interface
207 Axis control circuit
208 Spindle control circuit
209 PLC
210 I/O unit
21 First control unit
22 Second control unit
23 Third control unit
3 Input/output device
4 Servo amplifier
5 Tool rotation servomotor
6 X-axis servomotor
7 Y-axis servomotor
8 Z-axis servomotor
9 Spindle amplifier
10 Spindle motor
11 Auxiliary device
30 Estimation device
31 Reception unit
32 Storage unit
33 Determination unit
34 Calculation unit
35 Estimation unit
36 Output unit
Cw Center axis of workpiece
Cp Center axis of polygon
Rt Rotation axis of rotary tool
Rw Rotation axis of workpiece

1. An estimation device that, when a machine tool machines a polygon by controlling a relative position between a rotation axis of a rotary tool and a center axis of the polygon which is parallel to a rotation axis of a workpiece and passes through a predetermined position in the workpiece so that a positional relationship between the center axis of the polygon and the rotation axis of the rotary tool is kept constant, estimates whether interference will occur in the machine tool, the estimation device comprising:
a reception unit that receives model information regarding a structure that constitutes the machine tool;
a determination unit that, at a start of machining of the polygon, determines an initial position of the center axis of the polygon, an initial phase of the rotary tool, and a positional relationship between the center axis of the polygon and the rotation axis of the rotary tool;
a calculation unit that calculates a moving range of at least one of the rotation axis of the rotary tool and the rotation axis of the workpiece, based on the initial position of the center axis of the polygon, the initial phase of the rotary tool, and the positional relationship between the center axis of the polygon and the rotation axis of the rotary tool which are determined by the determination unit; and
an estimation unit that estimates whether interference will occur in the machine tool, based on the model information received by the reception unit and the moving range calculated by the calculation unit.

2. The estimation device according to claim 1, wherein when the estimation unit estimates that interference will occur, the determination unit, at the start of the machining of the polygon, changes at least one of the initial position of the center axis of the polygon, the initial phase of the rotary tool, and the positional relationship between the center axis of the polygon and the rotation axis of the rotary tool.

3. A computer-readable storage medium that stores an instruction that causes a computer to, when a machine tool machines a polygon by controlling a relative position between a rotation axis of a rotary tool and a center axis of the polygon which is parallel to a rotation axis of a workpiece and passes through a predetermined position in the workpiece so that a positional relationship between the center axis of the polygon and the rotation axis of the rotary tool is kept constant, estimate whether interference will occur in the machine tool, the instruction causing the computer to:
receive model information regarding a structure that constitutes the machine tool;
determine an initial position of the center axis of the polygon, an initial phase of the rotary tool, and a positional relationship between the center axis of the polygon and the rotation axis of the rotary tool at a start of machining of the polygon;
calculate a moving range of at least one of the rotation axis of the rotary tool and the rotation axis of the workpiece, based on the initial position of the center axis of the polygon, the initial phase of the rotary tool, and the positional relationship between the center axis of the polygon and the rotation axis of the rotary tool which are determined; and
estimate whether interference will occur in the machine tool, based on the received model information and the calculated moving range.
